(19) United States
(12) Patent Application Publication
(10) Pub. No.: US 2008/0197251 A1
(43) Pub. Date: Aug. 21, 2008

(54) Paint Pot Cover

(75) Inventor: Sylvain Fillon, La Boissiere-Ecole (FR)

Correspondence Address: YOUNG & THOMPSON, 209 Madison Street, Suite 500, ALEXANDRIA, VA, 22314, US

(73) Assignee: FILLON INVESTISSEMENT, Faverolles (FR)

(21) Appl. No.: 11/914,804

(22) PCT Filed: Apr. 21, 2006
(86) PCT No.: PCT/FR2006/000892

§ 371 Date: Dec. 11, 2007

(30) Foreign Application Priority Data
May 17, 2005 (FR) 0504935

(51) Int. Cl. B44D 3/12

(52) U.S. Cl. 248/213.2

(57) ABSTRACT

The invention relates to a cover (1) for closing a can that is equipped with an internal, radially peripheral rim, whereby said cover comprises at least two rotary cam (7) levers (2, 3), spring-loaded (4), and axially movable by so-called complementary surfaces (8; 10, 11, 12), respectively borne by the cover (1) and the cam lever (2, 3), working together during the driving in rotation of the levers (2, 3) to pass from a closed position of the cover (1), in which the cam (7) rests under the rim of the can, to an open position, in which the cam (7) is released from said rim, whereby the axial movement of the lever (2, 3) in the direction in which the cam (7) is removed from the cover (1) causes a compression of the spring (4).

This cover is characterized in that the complementary surfaces (8; 10, 11, 12) are shaped to have at least one zone (8; 10) of less stress on the spring (4) corresponding to the open position of the cover (1) for the purpose of preventing any premature wear on the spring (4).

This invention relates to a cover, preferably a measuring stirring apparatus, for closing a can, such as a paint can, equipped with an internal, radially peripheral rim that is generally close to its opening.

Cans, in particular cans containing paint, which are equipped with a removable cover comprising a stirring mechanism, have been known for a long time. The removable covers are most often attached to the can by cams that can be actuated from the outside of the cover by means of a lever. The cams are caused to pivot inside the can so that they can be applied more and more tightly against a support seating formed by the bottom of a ring or rim that borders the top of the can.

It appeared that certain products, in particular paints with aqueous solvent, cause corrosion of the metal cans commonly used in technology. To eliminate this drawback, the can manufacturers usually coat the inside wall of the can and the ring or rim that tops it by means of a varnish or other similar protective product. This protective method is satisfactory but it appeared that the covers that have a cam closure degrade the support seating of the rings on the cans by abrading the protective product since the cams rub vigorously against the seating when it is closed, and this effect causes corrosion to set in anew.

To solve this problem, the patent FR-A-2,707,258 describes a cover whose cam lever is, close to the closing position of the cover, in addition to its angular shift, driven by an axial movement owing to the presence of a slot that is provided on a ring of the cover, whereby this axial movement allows the cam of the lever to rest against the treated seating of the ring without damaging the latter. It should be noted that this axial movement also makes it possible to adapt to various dimensions of thickness of the rims.

In all the other positions of the cam lever, the cam is kept away from the seating of the rim by compression of a helicoidal spring that is positioned around the axis of the cam lever. This spring tends to expand for raising the cam lever only when the lever is in the closed position when the cam is in the slot of the ring. The result is that the spring is heavily stressed in all positions of the cam lever other than the closing position. These positions, other than that of closing, correspond to periods of disuse, and in particular storage. The latter can last for several months and be carried out under uncontrolled moisture and temperature conditions that are different from those of use. This heavy stress causes premature wear on the spring as well as a risk of fatigue deformation of the cam levers and the cover that are plastic parts.

This same drawback is noted for the cover that is described in the patent U.S. Pat. No. 6,336,740 where the slot was replaced by a ramp or else in the document U.S. Pat. No. 5,503,474 where the spring comes in the form of an elastically deformable tube.

One object of this invention is therefore to propose a cover of the type that is mentioned above whose design makes it possible to reduce the stress on the spring as much as possible at least in the opening position of the cover so as to prevent any premature wear on the spring and consequently a fatigue of the plastic parts.

Another object of the invention is to propose a cover whose design makes it possible to reduce the stress on the spring both in opening position and in closing position of the cover.

It should be recalled that henceforth, as heretofore, the term spring should be taken in its broadest accepted form, namely an elastic element that can support significant deformations and that is designed to exert a force that tends to resume its initial shape after having been, in particular, compressed.

For this purpose, the invention has as its object a cover, preferably a measuring stirring apparatus, for closing a can, such as a paint can that is equipped with an internal, radially peripheral rim that is generally close to its opening, whereby said cover comprises at least two rotary cam levers, spring-loaded, and axially movable by so-called complementary surfaces, respectively borne by the cover and the cam lever, working together during the driving in rotation of the levers to pass from a closed position of the cover, in which the cam rests under the rim of the can, to an open position, in which the cam is released from said rim, whereby the axial movement of the lever in the direction in which the cam is removed from the cover causes a compression of the spring, characterized in that the so-called complementary surfaces are shaped to have at least one zone of less stress on the spring corresponding to the open position of the cover for the purpose of preventing any premature wear on the spring and fatigue of the plastic parts.

According to a preferred embodiment of the invention, the so-called complementary surfaces are shaped to have at least two zones of less stress on the spring, one corresponding to the closed position of the cover and the other to the open position of the cover for the purpose of preventing any premature wear on the spring and fatigue of the plastic parts.

Owing to the shape imparted to the surfaces of the cover and the cam lever that are designed to work with one another to cause an axial movement of the cam lever, the result is that the spring is heavily stressed only in intermediate position between the open position and the closed position of the cam lever. As this intermediate position is only a transitory position in which the cam lever is not designed to be immobilized, any premature wear on said spring and fatigue of the plastic parts are thus avoided.

The invention will be better understood from reading the following description of embodiments with reference to the accompanying drawings, in which:

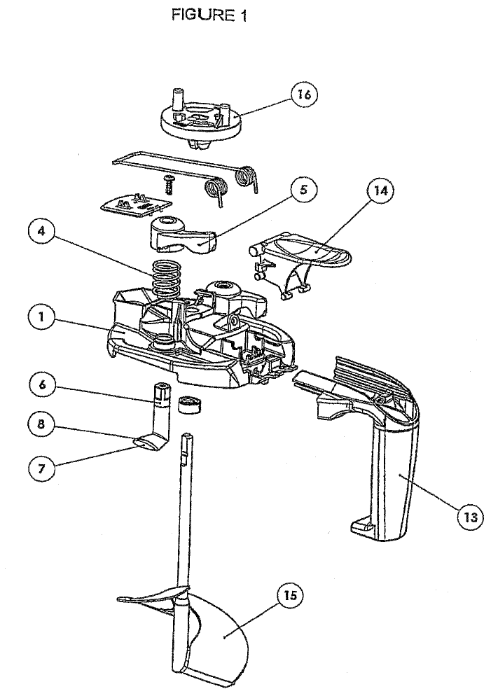

FIG. 1 shows a perspective view of a cover according to the invention in exploded position of the elements that constitute it;

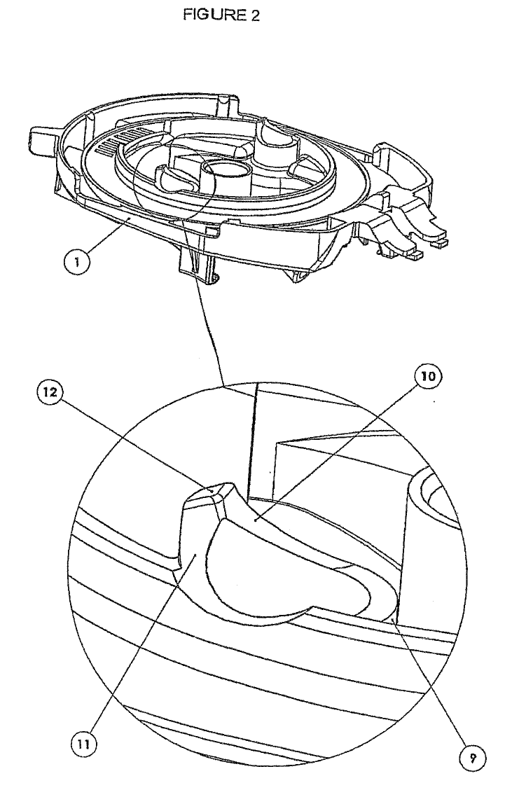

FIG. 2 shows a bottom view of a cover according to the invention, whereby the detail of the complementary surface of said cover has been enlarged;

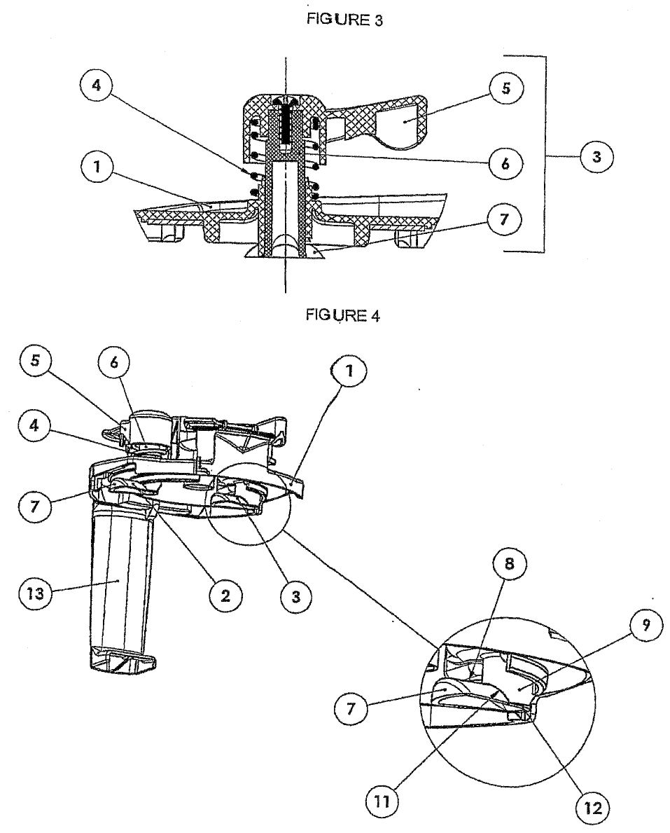

FIG. 3 shows a cutaway view of a cam lever that is positioned on said cover;

FIG. 4 shows a perspective view of a cover according to the invention, whereby one of the cams is in open position and the other is in the closed position of the cover, whereby the detail of the cam in open position has been enlarged;

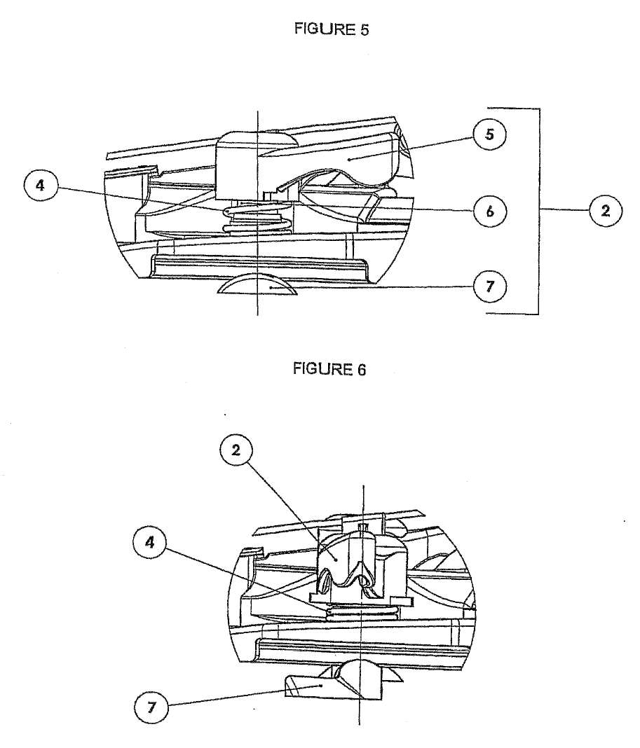

FIG. 5 is a partial elevation view that illustrates one of the cam levers in the open position or respectively the closed position of the cover, and

FIG. 6 is an elevation view analogous to FIG. 5 showing a cam lever in the position that it occupies in intermediate position.

As mentioned above, the cover 1, object of the invention, is more particularly designed to be applied to closing the can, such as a paint can, equipped with an internal, radially peripheral rim or a ring that is generally provided close to the opening of the can. Such a can generally comprises a lateral wall of revolution, most often cylindrical, produced from metal or optionally synthetic material. This lateral wall of the can supports at its top a ring that is, for example, clamped inside said wall. The ring or rim delimits a seating that is directed toward the base of the can and an upper face on which a flat seal with which the cover is equipped can rest.

Preferably, the face of the ring that is rotated toward the inside of the can is coated by a treatment material that is designed to protect the metal of the can from the risks of corrosion that can be caused by the product that is contained within the can. The cover, designed to close such a can, is generally equipped with a stirring mechanism 15, for example coil-shaped, which is mounted on a shaft that is driven by a coupling 16, itself moved by a drive element (not shown). The cover, equipped with a handle 13, comprises on its top a spout that is sealed by a sliding seal that can be moved by a trigger 14. Quite obviously, other types of spouts can also be considered.

To ensure the locking of the cover on the can, the cover is equipped on its bottom with cams that can each be maneuvered from a lever, the whole therefore being called a cam lever.

In the examples that are shown, the cover comprises at least two rotary cam 7 levers 2, 3. This number of cam levers is quite obviously based on the dimensions of the cover and the desired closing. These two cam levers are rotary levers that are each loaded by a spring 4 and can be moved axially by having so-called complementary surfaces, respectively borne by the cover 1 and the cam lever 2, 3, work together during the driving in rotation of the levers 2, 3. The angular shift of said levers thus makes it possible for the cams to pass from a closed position of the cover 1, in which the cam 7 rests under the rim of the can, to an open position, in which the cam 7 is released from said rim and extends in the direction of the interior of the can. The axial movement of the lever 2, 3 in the direction in which the cam 7 is removed from the cover 1 causes a compression of the spring 4.

In a manner that is characteristic of the invention, the so-called complementary surfaces 8; 10, 1, 12—respectively one 8 provided on the cam lever 2, 3 and the others 10, 11, 12 provided on the cover—are shaped to have at least one, preferably two zones 8; 10 and 8; 11 of less stress on the spring 4, one corresponding to the open position of the cover 1 and the other to the closed position of the cover 1 for the purpose of preventing any premature wear on the spring 4.

In the examples that are shown, the complementary surfaces 8; 10, 11, 12 are constituted by, for the surface 10, 11, 12 provided on the cover 1, the free edge of a tubular cylindrical boss 9 of the cover 1 that forms the axis bearing of the cam lever 2, 3. The other surface 8 is provided on the cam lever 2, 3 by the surface 8 of the cam 7 that is designed to come into contact with the rim of the can.

In an embodiment, not shown and corresponding to the case where the complementary surfaces 8, 10, 11, 12 are shaped to have a zone 8, 10 of less stress on the spring 4 corresponding to the open position of the cover 1, the complementary surface 10, 11, 12, provided on the cover 1, is formed by a ramp 10 that extends via two merged surfaces 11, 12 or in the extension from one another and positioned essentially at the same level and corresponding to a high point such that the stress on the spring 4 of the cam lever 2, 3 decreases during the movement upon contact of the cam lever from the zones 11, 12 on which the cam lever 2,3 is at rest in the closed or intermediate position of the lever in the direction of the free end of the ramp 10 on which the cam lever 2, 3 rests in open position. Therefore, in the open position, the spring 4 is least stressed, i.e., least compressed. Namely, it is in this position that there is a risk of wear on the spring and deformation of the plastic parts under stress, whereby this risk is linked to the impossibility of controlling the storage or transport conditions both in duration and in temperature.

In another embodiment that corresponds to the one that is shown in the figures, the complementary surface 10, 11, 12 that is provided on the cover 1 is formed by two ramps 10, 11 that are connected to one another, whereby the junction zone 12 of said ramps 10, 11 forms the top point of the latter such that the stress on the spring 4 of the cam lever 2, 3 decreases during the movement upon contact with the cam lever 2, 3 on said ramps 10, 11 from the junction zone 12 of the ramps 10, 11 corresponding to an intermediate position of the lever in the direction of the free ends of the ramps 10, 11 that correspond respectively: one, 10, to the open position of the cover 1, and the other, 11, to the closed position of the cover 1. Preferably, the ramps and their junction zone are formed by a single part with the cover. In this case, these ramps and their junction zone are provided, at the free edge, with a tubular cylindrical bore that forms the guide or axis bearing of the cam lever. Each cam lever 2, 3 is thus formed by a bent lever whose branch 5, positioned above the cover 1, constitutes the maneuvering element of the lever 2, 3 while the other branch 6, so-called lever axis, housed inside a bore that forms a guide bearing of the cover 1, is extended by an external radial projection that forms a cam 7 that is positioned below the cover 1. This cam has essentially the shape of a circular sector in plan, while the top 8 of said cam 7, designed to rest on a rim of the can, is shaped in the form of an arch or a corner.

The branch 5 of each bent lever 2, 3, designed to form the maneuvering element of said lever 2, 3, assumes a curved shape, generally at C with a hollow rotated toward the branch 5 that forms a maneuvering element with the other cam lever 3, 2. This same bent lever 2, 3 branch 5 forms—in its junction zone with the other branch of said lever—a case that encompasses the spring 4 that is sandwiched between the bottom of the case and the top, such as a salient boss, of the cover 1. In the examples that are shown, this spring 4 is a helicoidal spring that is designed to be wound around the second branch or axis of the cam lever. This spring would have been able to be produced in an equivalent manner in the form of an elastically deformable sleeve that is slipped onto the second branch or axis of the cam lever. This spring 4 tends to permanently keep the cam in contact with the ramp surface independently of the angular position of the lever.

To also facilitate the handling of such a cam lever, the branch 5 of each bent lever 2, 3, designed to form the maneuvering element of said lever 2, 3, has, on its face opposite the cover, a slot for insertion of a pin that can facilitate the handling of said branch.

When the cover 1 is separated from the can, the cam lever is rotated in a direction in which the cam is directed toward the inside of the cover while resting on the ramp 10 of the cover as FIG. 5 illustrates under the action of a weakly stressed spring.

To mount and lock the cover on the can, the cover is placed while being guided by studs so that its seal rests on the rim of the can. In this position, the top of the cams is in a plane that is parallel to the plane that is delimited by the bearing of the ring or rim of the can. By making the lever pivot, this drives the cam that slides along the ramp 10 by moving axially in the direction in which the cover is removed to reach the junction zone of said ramps, where it is furthest from the face of the bottom of the cover. The continuation of the angular shift of the lever causes the cam to move along the ramp 11 that tends to allow an axial shift of the cam lever in the direction of a drawing-together of the cam 8 of said cover to a position in which the cam rests against the rim of said can. Thus, during the passage from the open position to the closed position of the cover, the cam lever is moved in a first step in a downward axial movement before being driven in an upward axial movement once the junction zone between said ramps is passed. A reverse movement is achieved during the angular shift of the cam lever from the closed position of said cover in the direction of the open position of said cover. It is understood, owing to the shape imparted to the ramps, that the spring 4 is greatly compressed only when the cam rests on the junction zone between said ramps corresponding to an intermediate position of the cam lever. This intermediate position is not designed to be preserved and constitutes simply a transitory position between the positions of opening the cover and closing the cover. Thus, the heavy stress on the spring is not maintained. As a result, any premature wear on the spring is avoided. The configuration of the portion 12 of the junction zone between said ramps facilitates the mounting of the cam lever under the rims of the casing having rims of significant height.

Finally, in the closed position of the cam lever, the spring, which is always stressed in a more or less significant manner based on the height of the casing rim, may have, as was mentioned in the embodiment, not shown, a stress that can be equal to the one that is obtained in the intermediate position of the cam lever. As this stress is obtained under conditions of use that are controlled, the presence of this stress does not produce the consequences that are caused during a significant stress on the spring in open position of the cover.

Quite obviously, the complementary surfaces borne respectively by the cover and the cam lever could be provided at other locations than those described above without exceeding the scope of the invention.

1. Cover (1), preferably a measuring stirring apparatus, for closing a can, such as a paint can, equipped with an internal, radially peripheral rim that is generally close to its opening, whereby said cover comprises at least two rotary cam (7) levers (2, 3), spring-loaded (4), and axially movable by so-called complementary surfaces (8; 10, 11, 12), respectively borne by the cover (1) and the cam lever (2, 3), working together during the driving in rotation of the levers (2, 3) to pass from a closed position of the cover (1), in which the cam (7) rests under the rim of the can, to an open position, in which the cam (7) is released from said rim, whereby the axial movement of the lever (2, 3) in the direction in which the cam (7) is removed from the cover (1) causes a compression of the spring (4), characterized in that the so-called complementary surfaces (8; 10, 11, 12) are shaped to have at least one zone (8; 10) of less stress on the spring (4) corresponding to the open position of the cover (1) for the purpose of preventing any premature wear on the cover and fatigue of the plastic parts.

2. Stirring apparatus cover (1) according to claim 1, wherein the so-called complementary surfaces (8; 10, 11, 12) are shaped to have at least two zones (8; 10) (8; 11) of less stress on the spring (4), one corresponding to the open position of the cover (1) and the other to the closed position of the cover (1) for the purpose of preventing any premature wear on the spring (4).

3. Measuring stirring apparatus cover (1) according to claim 1, wherein the complementary surfaces (8; 10, 11, 12) are constituted by, for the surface (10, 11, 12) provided on the cover (1), the free edge of a tubular, cylindrical boss (9) of the cover (1) forming the axis bearing of the cam lever (2, 3), and for the surface (8) that is provided on the cam lever (2, 3) by the surface (8) of the cam (7) that is designed to come into contact with the rim of the can.

4. Measuring stirring apparatus cover (1) according to claim 2, wherein the complementary surface (10, 11, 12) that is provided on the cover (1) is formed by two ramps (10, 11) that are connected to one another, whereby the junction zone (12) of said ramps (10, 11) forms the high point of the latter such that the stress on the spring (4) of the cam lever (2, 3) decreases during the movement upon contact of the cam lever (2, 3) on said ramps (10, 11) from the junction zone (12) of the ramps (10, 11) that corresponds to an intermediate position of the lever (4) in the direction of the free ends of the ramps (10, 11) corresponding respectively: one to the open position of the cover (1), and the other to the closed position of the cover (1).

5. Stirring apparatus cover (1) according to claim 4, wherein the ramps and their junction zone are formed by a single part with the cover.

6. Measuring stirring apparatus cover (1) according to claim 1, wherein each cam lever (2, 3) is formed by a bent lever whose branch (5), positioned above the cover (1), constitutes the maneuvering element of the lever (2, 3) while the other branch (6), housed inside a bore that forms a guide bearing of the cover (1), is extended by an external radial projection that forms a cam (7) that is positioned below the cover (1), whereby the top (8) of said cam (7), designed to rest on a rim of the can, is shaped in the form of an arch or a corner.

7. Measuring stirring apparatus cover according to claim 6, wherein the branch (5) of each bent lever (2, 3), designed to form the maneuvering element of said lever (2, 3), assumes a curved shape, generally in a C with a hollow that is rotated toward the branch (5) that forms a maneuvering element of the other cam lever (3, 2).

8. Measuring stirring apparatus cover according to claim 6, wherein the branch (5) of each bent lever (2, 3), designed to form the maneuvering element of said lever (2, 3) has, on its face opposite to the cover, a slot for inserting a pin that can facilitate the handling of said branch.

9. Measuring stirring apparatus cover (1) according to claim 6, wherein the branch (5) of the bent lever (2, 3), designed to shape the maneuvering element of said lever, forms, in its junction zone with the other branch of said lever, a case that encompasses the spring (4) that is sandwiched between the bottom of the case and the top, such as a salient boss, of the cover (1).

10. Measuring stirring apparatus cover (1) according to claim 2, wherein the complementary surfaces (8; 10, 11, 12) are constituted by, for the surface (10, 11, 12) provided on the cover (1), the free edge of a tubular, cylindrical boss (9) of the cover (1) forming the axis bearing of the cam lever (2, 3), and for the surface (8) that is provided on the cam lever (2, 3) by the surface (8) of the cam (7) that is designed to come into contact with the rim of the can.
